(19) United States
(12) Patent Application Publication
(10) Pub. No.: US 2020/0347933 A1
(43) Pub. Date: Nov. 5, 2020

(54) CONTROL METHOD FOR POWER TRANSMISSION DEVICE, AND CONTROL DEVICE FOR POWER TRANSMISSION DEVICE

(71) Applicant: NISSAN MOTOR CO., LTD., Yokohama-shi, Kanagawa (JP)

(72) Inventors: Tomoyuki NAKANO, Kanagawa (JP); Ryohey TOYOTA, Kanagawa (JP); Kouichi KOTSUJI, Numazu-shi, Shizuoka (JP)

(73) Assignee: NISSAN MOTOR CO., LTD., Yokohama-shi, Kanagawa (JP)

(21) Appl. No.: 16/958,228

(22) PCT Filed: Dec. 20, 2018
(86) PCT No.: PCT/JP2018/047110

§ 371 Date: Jun. 26, 2020

(30) Foreign Application Priority Data
Dec. 28, 2017 (JP) 2017-254762

(51) Int. Cl. F16H 61/662; F16H 59/70

(52) U.S. Cl. CPC F16H 61/662; F16H 59/70; F16H 59/48; F16H 2059/704; F16H 2061/66218

(57) ABSTRACT

A control method for a power transmission device includes: determining whether a difference between an actual speed ratio of a variator and a speed ratio at which a movable pulley contacts a stopper is equal to or less than a predetermined value; and performing a switching of a switching valve when being determined that the difference is equal to or less than the predetermined value.

### TECHNICAL FIELD

The present invention relates to a control method for a power transmission device and a control device for the power transmission device.

### BACKGROUND ART

JP2005-30495A discloses a belt continuously variable transmission in which an electric oil pump for shift is provided in an oil passage communicating between a primary pulley oil chamber and a secondary pulley oil chamber. The technology of JP2005-30495A employs a switching valve for using the electric oil pump for shift as a pump for a source pressure.

### SUMMARY OF INVENTION

It is conceivable to supply oil in an oil reservoir to the primary pulley oil chamber by using the electric oil pump for shift as the pump for the source pressure by the switching of the switching valve as described above.

However, because the hydraulic pressure of the oil sump is equivalent to atmospheric pressure when switching the switching valve from a state where oil in the oil reservoir is supplied to the primary pulley oil chamber, for example, smaller hydraulic pressure is transmitted to the primary pulley oil chamber compared to before switching the switching valve. As a result, hydraulic pressure fluctuation occurs in the primary pulley oil chamber, and a speed ratio is unintentionally changed when a primary pulley operates in accordance with the hydraulic pressure fluctuation such as this one. This may result in the shift shock.

The present invention has been made in view of such problems, and an object of the present invention is to provide a control method for a power transmission device and a control device for the power transmission device in which oil in the oil reservoir can be supplied to the primary pulley oil chamber via the electric oil pump for shift by the switching of the switching valve and the shift shock according to the switching of the switching valve can be suppressed.

According to a certain aspect of the present invention, provided is a control method for a power transmission device including a continuously variable transmission mechanism configured to perform power transmission between a driving source and driving wheels, a first oil passage communicating between a primary pulley oil chamber and a secondary pulley oil chamber of the continuously variable transmission mechanism, an electric oil pump provided in the first oil passage, a second oil passage branching off from the first oil passage between the electric oil pump and the primary pulley oil chamber and communicating with an oil reservoir, a switching valve provided at a branch point of the first oil passage and the second oil passage, and a third oil passage branching off from the first oil passage between the electric oil pump and the secondary pulley oil chamber and reaching the switching valve. The switching valve is configured to switch between two positions of a first position at which at least the first oil passage is set to a communication state and a second position at which the second oil passage and the first oil passage on a secondary pulley oil chamber side are set to a communication state with each other and the third oil passage and the first oil passage on a primary pulley oil chamber side are set to a communication state with each other. The control method includes determining whether a difference between an actual speed ratio of the continuously variable transmission mechanism and a speed ratio at which an axial movable part of a primary pulley or a secondary pulley of the continuously variable transmission mechanism contacts a stopper is equal to or less than a predetermined value, and performing a switching of the switching valve when being determined that the difference is equal to or less than the predetermined value.

According to another aspect of the present invention, provided is a control method for a power transmission device including a continuously variable transmission mechanism configured to perform power transmission between a driving source and driving wheels, first oil passage communicating between a primary pulley oil chamber and a secondary pulley oil chamber of the continuously variable transmission mechanism, an electric oil pump provided in the first oil passage, a second oil passage branching off from the first oil passage between the electric oil pump and the primary pulley oil chamber and communicating with an oil reservoir, a switching valve provided at a branch point of the first oil passage and the second oil passage, and a third oil passage branching off from the first oil passage between the electric oil pump and the secondary pulley oil chamber and reaching the switching valve. The switching valve is configured to switch between two positions of a first position at which at least the first oil passage is set to a communication state and a second position at which the second oil passage and the first oil passage on a secondary pulley oil chamber side are set to a communication state with each other and the third oil passage and the first oil passage on a primary pulley oil chamber side are set to a communication state with each other. The control method includes determining whether there is contact between a stopper and an axial movable part of a primary pulley or a secondary pulley of the continuously variable transmission mechanism, and performing a switching of the switching valve when being determined that there is the contact.

According to yet another aspect of the present invention, control devices for the power transmission devices corresponding to these control methods for the power transmission devices are provided.

### BRIEF DESCRIPTION OF DRAWINGS

FIG. 1 is a schematic configuration diagram illustrating the main parts of a vehicle.

FIG. 2A is the first diagram of an explanatory diagram of the switching position of a switching valve.

FIG. 2B is the second diagram of the explanatory diagram of the switching position of the switching valve.

FIG. 3A is a diagram illustrating a first operating state of a variator.

FIG. 3B is a diagram illustrating a second operating state of the variator.

FIG. 4 is a flowchart illustrating an example of control performed by a controller.

FIG. 5 is a diagram illustrating a first example of a timing chart.

FIG. 6 is a diagram illustrating a second example of the timing chart.

FIG. 7 is a flowchart illustrating a modified example of control performed by the controller.

FIG. 8 is a diagram illustrating an example of a timing chart corresponding to the modified example.

### DESCRIPTION OF EMBODIMENTS

Hereinafter, exemplary embodiments of the present invention will be explained with reference to the accompanying drawings.

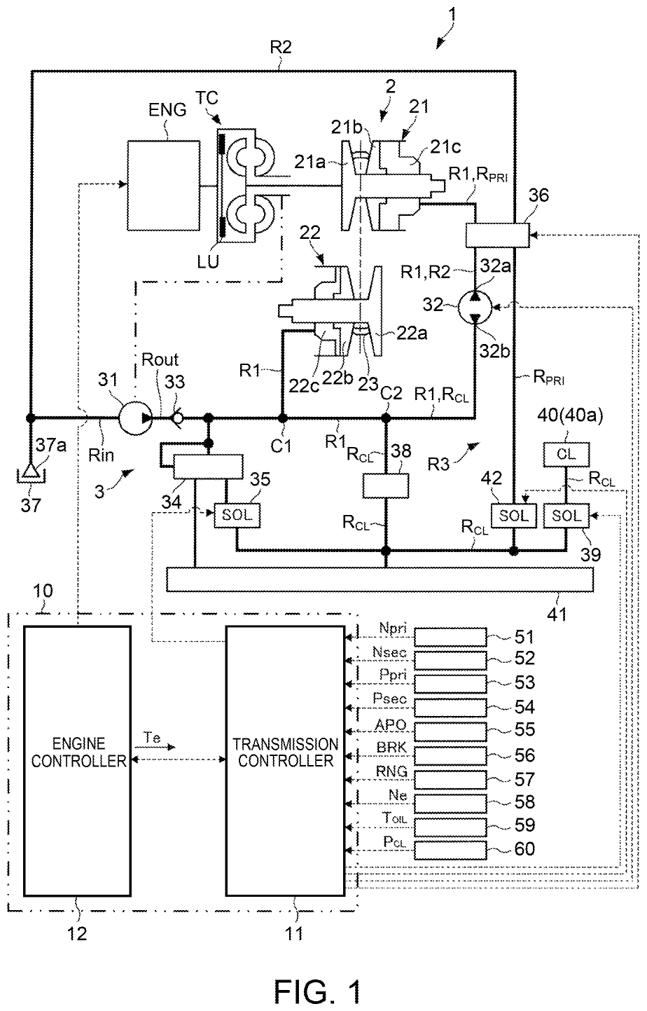

FIG. 1 is a schematic configuration diagram illustrating the main parts of a vehicle. A transmission 1 is a belt continuously variable transmission, and is mounted on the vehicle together with an engine ENG constituting a driving source of the vehicle. The rotation from the engine ENG is input to the transmission 1. The output rotation of the engine ENG is input to the transmission 1 via a torque converter TC etc. having a lock-up clutch LU. The transmission 1 outputs the input rotation at a rotation according to a speed ratio. The speed ratio is a value obtained by dividing the input rotation by the output rotation.

The transmission 1 includes a variator 2 and a hydraulic circuit 3.

The variator 2 is provided in a power transmission path connecting the engine ENG and driving wheels not illustrated, and performs power transmission between these. The variator 2 is a belt continuously variable transmission mechanism that includes a primary pulley 21, a secondary pulley 22, and a belt 23 wrapped around the primary pulley 21 and the secondary pulley 22.

The variator 2 changes the wrapping diameter of the belt 23 to perform the shift by changing the groove widths of the primary pulley 21 and the secondary pulley 22. Hereinafter, “primary” is referred to as PRI and “secondary” is referred to as SEC.

The PRI pulley 21 includes a fixed pulley 21a, a movable pulley 21b, and a PRI pulley oil chamber 21c. In the PRI pulley 21, oil is supplied to the PRI pulley oil chamber 21c. When the movable pulley 21b moves due to the oil in the PRI pulley oil chamber 21c, the groove width of the PRI pulley 21 is changed.

The movable pulley 21b constitutes an axial movable part that moves in the axial direction of the variator 2 in accordance with a PRI pressure Ppri. The PRI pressure Ppri is the pulley pressure of the PRI pulley 21 and specifically is the hydraulic pressure of the PRI pulley oil chamber 21c. The axial movable part may be a member other than the movable pulley 2 lb, which moves in the axial direction together with the movable pulley 21b.

The SEC pulley 22 includes a fixed pulley 22a, a movable pulley 22b, and an SEC pulley oil chamber 22c. In the SEC pulley 22, oil is supplied to the SEC pulley oil chamber 22c. When the movable pulley 22b moves due to the oil in the SEC pulley oil chamber 22c, the groove width of the SEC pulley 22 is changed.

The movable pulley 22b constitutes an axial movable part that moves in the axial direction of the variator 2 in accordance with an SEC pressure Psec. The SEC pressure Psec is the pulley pressure of the SEC pulley 22 and specifically is the hydraulic pressure of the SEC pulley oil chamber 22c. The axial movable part may be a member other than the movable pulley 22b, which moves in the axial direction together with the movable pulley 22b.

The belt 23 is wrapped around a V-shaped sheave surface formed by the fixed pulley 21a and the movable pulley 21b of the PRI pulley 21 and a V-shaped sheave surface formed by the fixed pulley 22a and the movable pulley 22b of the SEC pulley 22. The belt 23 is held by a belt clamping force generated by the SEC pressure Psec.

The hydraulic circuit 3 includes, in addition to the PRI pulley oil chamber 21c and the SEC pulley oil chamber 22c, a mechanical oil pump 31, an electric oil pump 32, a check valve 33, a line pressure adjusting valve 34, a line pressure solenoid 35, a switching valve 36, an oil reservoir 37, a pilot valve 38, a clutch pressure solenoid 39, a clutch 40, a T/C hydraulic system 41, and a PRI pressure solenoid 42. These configurations constitute the hydraulic circuit 3 together with oil passages as described below.

The PRI pulley oil chamber 21c and the SEC pulley oil chamber 22c are communicated by a first oil passage R1. The mechanical oil pump 31 is connected to the first oil passage R1 via a discharge-side oil passage Rout of the mechanical oil pump 31. The mechanical oil pump 31 is a mechanical oil pump driven by the power of the engine ENG, and is coupled to the impeller of the torque converter TC via a power transmission member as schematically illustrating the coupled state with a two-point dashed line.

The check valve 33 is provided in the discharge-side oil passage Rout. The check valve 33 prevents the flow of oil toward the mechanical oil pump 31 and allows the flow of oil in the opposite direction. The line pressure adjusting valve 34 is connected to the discharge-side oil passage Rout at a portion downstream from the check valve 33.

The line pressure adjusting valve 34 adjusts a pressure of oil supplied from the mechanical oil pump 31 to a line pressure PL. The line pressure adjusting valve 34 operates in accordance with a solenoid pressure generated by the line pressure solenoid 35. In the present embodiment, the line pressure PL is supplied to the SEC pulley oil chamber 22c as the SEC pressure Psec.

The electric oil pump 32 and the switching valve 36 are provided in the first oil passage R1. The electric oil pump 32 is provided in the first oil passage R1 at a portion closer to the PRI pulley oil chamber 21c than a first point Cl that is a point to which the discharge-side oil passage Rout is connected. The electric oil pump 32 is rotatable in forward and reverse directions. Specifically, the forward direction is a direction of supplying oil to the PRI pulley oil chamber 21c side and the reverse direction is a direction of supplying oil to the SEC pulley oil chamber 22c side.

The switching valve 36 is provided in the first oil passage R1 between the electric oil pump 32 and the PRI pulley oil chamber 21c. The switching valve 36 includes a first position P1 and a second position P2 as switching positions, and is configured to be able to switch between the first position P1 and the second position P2. The switching positions of the switching valve 36 will be described below.

The electric oil pump 32 communicates with the oil reservoir 37 through a second oil passage R2. Specifically, the second oil passage R2 is connected to a strainer 37a in the oil reservoir 37. The second oil passage R2 includes an oil passage communicating between the oil reservoir 37 and the switching valve 36 and a portion of the first oil passage R1 between the switching valve 36 and the electric oil pump 32. The former oil passage is an oil passage not including other oil passages connected to the switching valve 36. The switching valve 36 is provided to connect these oil passages, and consequently is further provided in the second oil passage R2.

Specifically, the second oil passage R2 is connected to an oil inlet/outlet port 32a of the electric oil pump 32 on the PRI pulley oil chamber 21c side. The portion of the first oil passage R1 between the switching valve 36 and the electric oil pump 32 also serves as a part of the second oil passage R2. The mechanical oil pump 31 is also connected via a suction-side oil passage Rin to a portion of the second oil passage R2 closer to the oil reservoir 37 than the switching valve 36.

Such the second oil passage R2 and the switching valve 36 can be grasped as described below. That is, the second oil passage R2 can be grasped as an oil passage branching off from the first oil passage R1 between the electric oil pump 32 and the PRI pulley oil chamber 21c and communicating with the oil reservoir 37. Moreover, the switching valve 36 can be grasped as a switching valve provided at a branch point of the first oil passage R1 and the second oil passage R2.

The oil reservoir 37 is an oil reservoir that stores oil to be supplied by the mechanical oil pump 31 and the electric oil pump 32, and oil is sucked from the oil reservoir 37 via the strainer 37a. The oil reservoir 37 may be constituted by a plurality of oil reservoir.

The electric oil pump 32 communicates with the clutch 40, specifically, a clutch oil chamber 40a of the clutch 40 via a clutch oil passage RCL. The clutch oil passage RCL includes a portion of the first oil passage R1 between the electric oil pump 32 and a second point C2. The second point C2 is a point in the first oil passage R1 between the electric oil pump 32 and the first point Cl. The clutch oil passage RCL further includes an oil passage communicating between the second point C2 and the clutch 40.

Specifically, the clutch oil passage RCL is connected to an oil inlet/outlet port 32b of the electric oil pump 32 on the SEC pulley oil chamber 22c side. The portion of the first oil passage R1 between the electric oil pump 32 and the second point C2 also serves as a part of the clutch oil passage R_{CL}. The clutch oil passage RCL is an oil passage not including the second oil passage R2.

The clutch 40 is engaged by supplying oil to the clutch oil chamber 40a and is disengaged by draining oil from the clutch oil chamber 40a. The clutch 40 performs the power transmission between the engine ENG and the driving wheels together with the variator 2. The clutch 40 performs connection and disconnection of the power transmission path connecting the engine ENG and the driving wheels. The clutch 40 constitutes hydraulic device other than the variator 2.

The pilot valve 38 is provided in the clutch oil passage RCL at a portion branching off from the first oil passage R1. Moreover, the clutch pressure solenoid 39 is provided in the clutch oil passage RCL at a portion between the pilot valve 38 and the clutch 40. The pilot valve 38 reduces the pressure of oil supplied from the first oil passage R1. The clutch pressure solenoid 39 adjusts a hydraulic pressure supplied to the clutch 40, namely, a hydraulic pressure PCL in the clutch oil chamber 40a.

Further, a PRI oil passage Rpm branches off from the clutch oil passage RCL and communicates with the PRI pulley oil chamber 21c. The PRI oil passage RPRI includes an oil passage communicating between the clutch oil passage RCL and the switching valve 36 and a portion of the first oil passage R1 between the switching valve 36 and the PRI pulley oil chamber 21c. The former oil passage is an oil passage not including other oil passages connected to the switching valve 36. The switching valve 36 is provided to connect these oil passages, and consequently is further provided in the PRI oil passage RPRI.

Specifically, the PRI oil passage RPRI branches off from the clutch oil passage R_{CL} between the pilot valve 38 and the clutch pressure solenoid 39. Moreover, the PRI pressure solenoid 42 is provided in the PRI oil passage RPRI. The PRI pressure solenoid 42 is a pressure control valve that adjusts a pressure of oil supplied to the PRI pulley oil chamber 21c, and is provided in the PRI oil passage Rpₘ between the switching valve 36 and the clutch oil passage R_{CL}. The portion of the first oil passage R1 between the PRI pulley oil chamber 21c and the switching valve 36 also serves as a part of the PRI oil passage RPRI.

Such the PRI oil passage Rpm can be grasped as a third oil passage R3 branching off from the first oil passage R1 between the electric oil pump 32 and the SEC pulley oil chamber 22c and reaching the switching valve 36, together with a part of the clutch oil passage R_{CL} (specifically, the clutch oil passage R_{CL} between the second point C2 and the point from which the PRI oil passage Rpₘ branches).

In addition, oil passages are provided in the hydraulic circuit 3. The oil passages branch off from the clutch oil passage R_{CL} at a portion between the pilot valve 38 and the clutch pressure solenoid 39 and are respectively connected to the line pressure solenoid 35 and the T/C hydraulic system 41.

The line pressure solenoid 35 generates a solenoid pressure according to a command value of the line pressure PL and supplies the solenoid pressure to the line pressure adjusting valve 34. The T/C hydraulic system 41 is a hydraulic system for the torque converter TC that includes the lock-up clutch LU, and oil drained from the line pressure adjusting valve 34 is also supplied to the T/ C hydraulic system 41.

In the hydraulic circuit 3 thus configured, the mechanical oil pump 31 supplies the SEC pressure Psec to the SEC pulley oil chamber 22c, and the electric oil pump 32 controls the supply and discharge of the oil to and from the PRI pulley oil chamber 21c. The mechanical oil pump 31 is used for holding the belt 23, and the electric oil pump 32 is used for the shift.

That is, as a shift principle, the shift is performed by moving oil from one to the other of the PRI pulley oil chamber 21c and the SEC pulley oil chamber 22c by the electric oil pump 32.

A controller 10 is further provided in the vehicle. The controller 10 is configured to include a transmission controller 11 and an engine controller 12.

Signals from a rotation sensor 51 for detecting the input-side rotation speed of the variator 2, a rotation sensor 52 for detecting the output-side rotation speed of the variator 2, a pressure sensor 53 for detecting the PRI pressure Ppri, and a pressure sensor 54 for detecting the SEC pressure Psec are input to the transmission controller 11. The rotation sensor 51 specifically detects a rotation speed Npri of the PRI pulley 21. The rotation sensor 52 specifically detects a rotation speed Nsec of the SEC pulley 22. The transmission controller 11 can detect a vehicle speed VSP based on the input from the rotation sensor 52.

Furthermore, signals from an accelerator pedal opening sensor 55, a brake sensor 56, a selected range detection switch 57, an engine rotation sensor 58, an oil temperature sensor 59, and a hydraulic sensor 60 are input to the transmission controller 11.

The accelerator pedal opening sensor 55 detects an accelerator pedal opening APO indicating the operation amount of an accelerator pedal. The brake sensor 56 detects a brake pedal depression force BRK. The selected range detection switch 57 detects a range RNG selected by a shift lever that is a selector. The engine rotation sensor 58 detects a rotation speed Ne of the engine ENG. The oil temperature sensor 59 detects an oil temperature TOIL of the transmission 1. The oil temperature TOIL is the temperature of oil used as hydraulic oil in the variator 2. The hydraulic sensor 60 detects the hydraulic pressure PCL.

The transmission controller 11 is connected to the engine controller 12 so as to be communicable with each other. Herein, engine torque information Te is input to the transmission controller 11 from the engine controller 12. The signals from the accelerator pedal opening sensor 55 and the engine rotation sensor 58 may be input to the transmission controller 11 via the engine controller 12, for example.

The transmission controller 11 generates a control signal including a shift control signal based on the input signals, and outputs the generated control signal to the hydraulic circuit 3. In the hydraulic circuit 3, the electric oil pump 32, the line pressure solenoid 35, the switching valve 36, the clutch pressure solenoid 39, the PRI pressure solenoid 42, and the like are controlled based on the control signal from the transmission controller 11. As a result, the speed ratio of the variator 2 is controlled to a speed ratio according to the shift control signal, that is, a target speed ratio, for example.

In the present embodiment, the controller 10 including the transmission controller 11 and the engine controller 12 constitutes a power transmission device together with the transmission 1.

Next, the switching positions of the switching valve 36 will be explained.

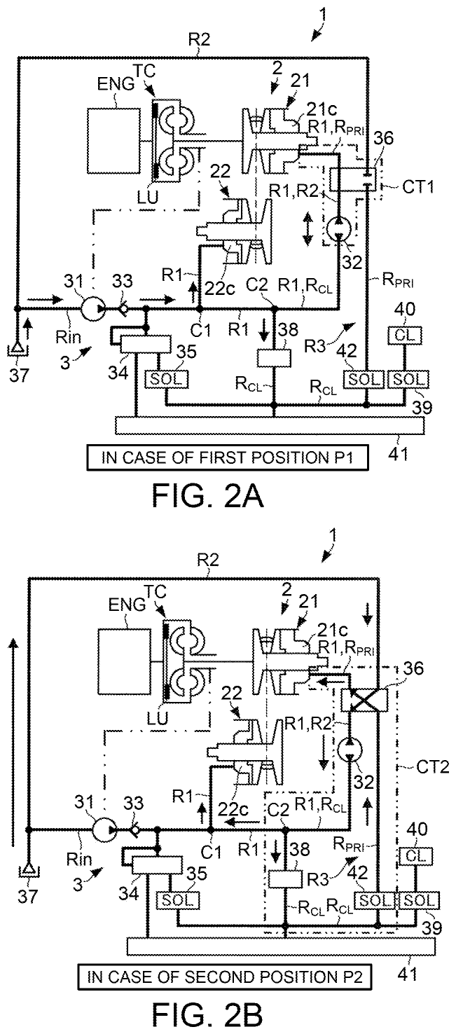

FIGS. 2A and 2B are explanatory diagrams of the switching positions of the switching valve 36. FIG. 2A illustrates a case where the switching position, i.e., a valve position is the first position P1 and FIG. 2B illustrates a case where the switching position is the second position P2.

The first position P1 is a switching position at which the first oil passage R1 is set to the communication state and the second oil passage R2 is set to the blocked state. The PRI oil passage RPRI is further set to the blocked state at the first position P1. As a result, in the case of the first position P1, the mechanical oil pump 31 supplies the oil in the oil reservoir 37 to the SEC pulley oil chamber 22c and the clutch 40, and the electric oil pump 32 controls the supply and discharge of the oil to and from the PRI pulley oil chamber 21c.

The second position P2 is a switching position at which the first oil passage R1 is set to the blocked state and the second oil passage R2 is set to the communication state. The PRI oil passage RPRI is further set to the communication state at the second position P2. As a result, in the case of the second position P2, the electric oil pump 32 communicates with the clutch 40 and the PRI pulley oil chamber 21c, and supplies the oil in the oil reservoir 37 to the clutch 40 and the PRI pulley oil chamber 21c.

Furthermore, in the case of the second position P2, the oil in the clutch oil passage RCL can be adjusted in pressure by the PRI pressure solenoid 42 and supplied to the PRI pulley oil chamber 21c. Therefore, even if the first oil passage R1 is blocked by the switching valve 36, the variator 2 can be shifted.

The first position P1 and the second position P2 will be further explained. A first PRI circuit CT1 is formed at the first position P1. The first PRI circuit CT1 is a first supply/discharge circuit formed at the first position P1 as a circuit supplying/discharging oil to/from the PRI pulley oil chamber 21c. Specifically, the first PRI circuit CT1 is configured to include the electric oil pump 32, the switching valve 36, and the oil passages provided between the electric oil pump 32 and the PRI pulley oil chamber 21c.

The hydraulic pressure of the first PRI circuit CT1 is a PRI-side pressure Pc1 controlled by the electric oil pump 32. The PRI-side pressure Pc1 is a hydraulic pressure on the PRI pulley oil chamber 21c side, that is, the oil inlet/outlet port 32a side of the electric oil pump 32. Specifically, the PRI-side pressure Pc1 is indicated by the hydraulic pressure in the first PRI circuit CT1 between the electric oil pump 32 and the switching valve 36 through the formed period and blocked period of the first PRI circuit CT1.

A second PRI circuit CT2 is formed at the second position P2. The second PRI circuit CT2 is a second supply/discharge circuit formed at the second position P2 as a circuit supplying/discharging oil to/from the PRI pulley oil chamber 21c. Specifically, the second PRI circuit CT2 is configured to include the electric oil pump 32, the pilot valve 38, the PRI pressure solenoid 42, the switching valve 36, and the oil passages provided between the electric oil pump 32 and the PRI pulley oil chamber 21c.

The hydraulic pressure of the second PRI circuit CT2 is a SOL pressure Pc2 controlled by the PRI pressure solenoid 42. The SOL pressure Pc2 is the hydraulic pressure on the PRI pulley oil chamber 21c side that is, the downstream side of the PRI pressure solenoid 42. Specifically, the SOL pressure Pc2 is indicated by the hydraulic pressure in the second PRI circuit CT2 between the PRI pressure solenoid 42 and the switching valve 36 through the formed period and blocked period of the second PRI circuit CT2.

Such the switching valve 36 can be grasped as described below in addition to the fact that the second oil passage R2 and the switching valve 36 can be grasped as described above. That is, the switching valve 36 can be grasped as a switching valve switching between two positions of the first position P1 at which at least the first oil passage R1 is set to the communication state and the second position P2 at which the second oil passage R2 and the first oil passage R1 on the SEC pulley oil chamber 22c side are set to the communication state and the third oil passage R3 and the first oil passage R1 on the PRI pulley oil chamber 21c side are set to the communication state.

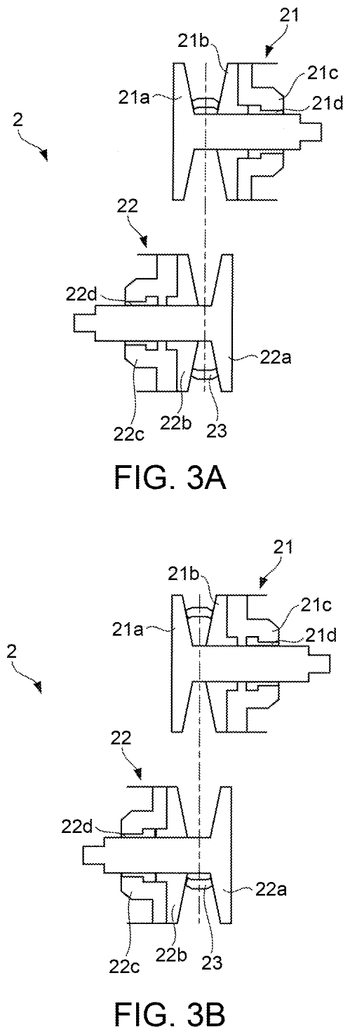

FIG. 3A is a diagram illustrating a first operating state of the variator 2. FIG. 3B is a diagram illustrating a second operating state of the variator 2. The first operating state is an operating state when the speed ratio of the variator 2 is the lowest speed ratio (i.e., the maximum speed ratio). The second operating state is an operating state when the speed ratio of the variator 2 is the highest speed ratio (i.e., the minimum speed ratio).

As illustrated in FIGS. 3A and 3B, the variator 2 further includes a stopper 21d and a stopper 22d. The stopper 21d is a mechanical stopper for stopping an axial movement in the PRI pulley 21. When the movable pulley 21 b contacts the stopper 21d, the further movement of the movable pulley 21b toward the stopper 21d is prevented. The same applies to the stopper 22d and the movable pulley 22b provided in the SEC pulley 22. The movable pulley 21b contacts the stopper 21d when the speed ratio of the variator 2 is the lowest speed ratio, and the movable pulley 22b contacts the stopper 22d when the speed ratio of the variator 2 is the highest speed ratio.

In the present embodiment, as previously described by using FIG. 2B, the oil in the oil reservoir 37 can be supplied to the PRI pulley oil chamber 21c via the electric oil pump 32 by the switching of the switching valve 36.

However, because the hydraulic pressure of the oil reservoir 37 is equivalent to atmospheric pressure when switching the switching valve 36 from the second position P2 to the first position P1, for example, smaller hydraulic pressure is transmitted to the PRI pulley oil chamber 21c compared to before switching the switching valve 36. As a result, hydraulic pressure fluctuation occurs in the PRI pulley oil chamber 21c, and when the PRI pulley 21 operates in accordance with this hydraulic pressure fluctuation, a speed ratio is unintentionally changed. Thus, there is a concern that the shift shock may occur.

In light of these circumstances, the controller 10 performs the control described as follows in the present embodiment.

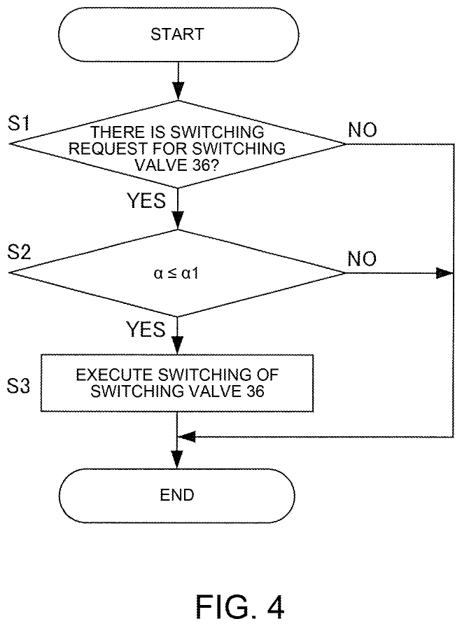

FIG. 4 is a flowchart illustrating an example of control performed by the controller 10. The controller 10 is configured as a control device for the power transmission device that includes a determining unit and a control unit by being configured to execute the processings of the present flowchart.

In Step S1, the controller 10 determines whether there is a switching request for the switching valve 36. Herein, the second position P2 of the switching valve 36 illustrated in FIG. 2B is applied at the time of the idling stop of the engine ENG, for example. The idling stop is a driving-source automatic stop control, and is executed when an idling stop condition described later is satisfied.

Accordingly, the controller 10 can determine whether there is a switching request for the switching valve 36 from the first position P1 to the second position P2 by determining whether the idling stop condition is satisfied. Moreover, the controller 10 can determine whether there is a switching request for the switching valve 36 from the second position P2 to the first position P1 by determining whether the idling stop condition is not satisfied.

The idling stop condition is a condition including that the vehicle speed VSP is zero, that the brake pedal is depressed, and that the accelerator pedal is not depressed. The idling stop condition is satisfied when all conditions included in the idling stop condition are satisfied. The idling stop condition is not satisfied when any of the conditions included in the idling stop condition is not satisfied. If a negative determination is made in Step 51, the processings once return to the end. If a positive determination is made in Step 51, the processings proceed to Step S2.

In Step S2, the controller 10 determines whether a difference a is equal to or less than a predetermined value a 1. The difference a is a difference between an actual speed ratio of the variator 2 and a speed ratio at which the movable pulley 21b contacts the stopper 21d or a speed ratio at which the movable pulley 22b contacts the stopper 22d.

When the switching of the switching valve 36 is performed at the time of executing or stopping the idling stop, the difference a specifically is a difference between the actual speed ratio of the variator 2 and the speed ratio at which the movable pulley 21b contacts the stopper 21d, that is, the Lowest speed ratio.

The predetermined value α1 is previously set as a value by which a change in vehicle acceleration due to the hydraulic pressure fluctuation of the PRI pressure Ppri or the SEC pressure Psec when performing the switching of the switching valve 36 is within an allowable range. The change in vehicle acceleration can be represented by an amount of change in vehicle acceleration, and “within the allowable range” can be “equal to or less than an allowable value”. If a negative determination is made in Step S2, the processings are once terminated. If a positive determination is made in Step S2, the processings proceed to Step S3.

In Step S3, the controller 10 executes the switching of the switching valve 36. Thus, even if the hydraulic pressure fluctuation occurs to cause the shift shock in accordance with the switching of the switching valve 36, the switching of the switching valve 36 can be performed if the shift shock is within the allowable range. After Step S3, the processings are once terminated.

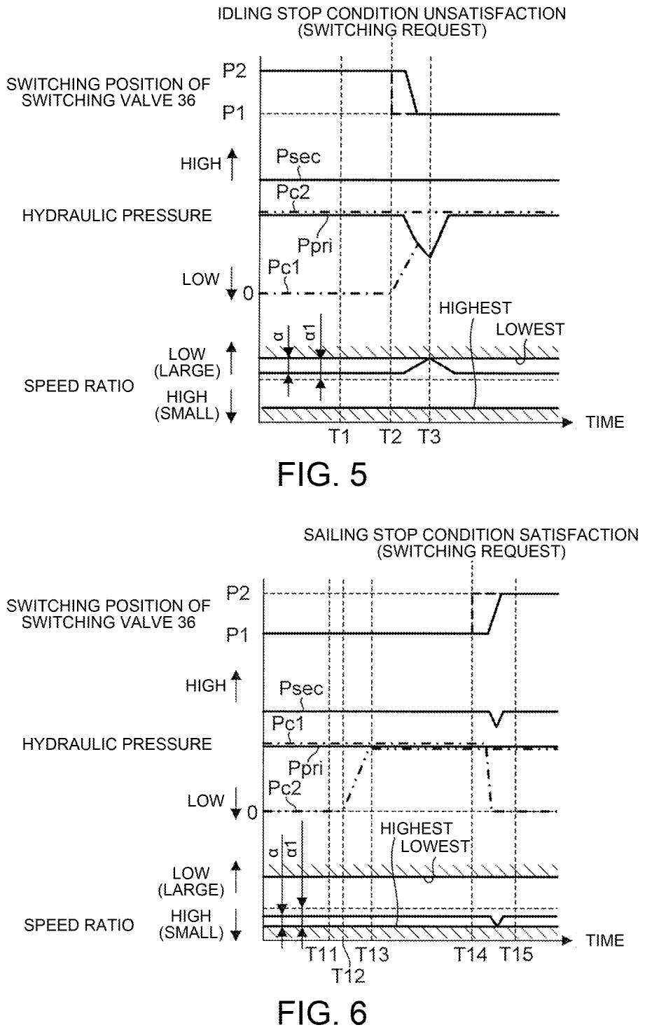

FIG. 5 is a diagram illustrating a first example of a timing chart corresponding to the flowchart illustrated in FIG. 4. A case where the idling stop condition is not satisfied, therefore a case where the switching of the switching valve 36 is performed from the second position P2 to the first position P1 will be explained in FIG. 5.

At a time T1, the idling stop is in the execution and the switching position of the switching valve 36 is the second position P2. The PRI pressure Ppri is constituted by the SOL pressure Pc2, and the SEC pressure Psec is set to be higher than the PRI pressure Ppri. The PRI-side pressure Pc1 is zero in gauge pressure, that is, atmospheric pressure. The speed ratio of the variator 2 is closer to the lowest speed ratio, and the difference a is equal to or less than the predetermined value α1.

At a time T2, the idling stop condition is not satisfied, and a switching request for the switching valve 36 from the second position P2 to the first position P1 occurs. Therefore, a switching command for the switching valve 36 from the second position P2 to the first position P1 is issued as indicated by a dashed line, and the switching of the switching valve 36 is started. The switching request can be continued until the switching of the switching valve 36 is completed.

At the time T2, in accordance with the idling stop condition not being satisfied, the rotation direction of the electric oil pump 32 is switched from a reverse direction to a forward direction. As a result, the PRI-side pressure Pc1 starts to increase.

The switching of the switching valve 36 is during the transition from the time T2 to a time T3. The transition of the switching can be divided into the previous term, the middle term, and the later term of the transition.

First, in the previous term of the transition, the PRI oil passage RPRI and the second oil passage R2 communicated at the second position P2 illustrated in FIG. 2B are gradually blocked. In other words, in the previous term of the transition, the PRI oil passage RPRI and the second oil passage R2 are not completely blocked, and the switching position remains at the second position P2.

In the middle term of the transition, the PRI oil passage RPRI and the second oil passage R2 are blocked. The first oil passage R1 blocked by the switching valve 36 at the second position P2 also remains blocked. Therefore, the switching position in the middle term of the transition is indicated by a degree of progress of the switching in a state where these oil passages are blocked. In the middle term of the transition, because oil is not supplied to the PRI pulley oil chamber 21c through the PRI pressure solenoid 42, the PRI pressure Ppri starts to decrease.

In the later term of the transition, the switching valve 36 makes the first oil passage R1 start to communicate and thus the switching position becomes the first position P 1. When the first oil passage R1 starts to communicate, the PRI pressure Ppri is constituted by the PRI-side pressure Pc1. In this case, the PRI pressure Ppri is decreased as being dragged by the PRI-side pressure Pc1 that was atmospheric pressure before the switching of the switching valve 36, and then is turned to increase to have the same magnitude as the SOL pressure Pc2 that is controlled to a target pressure of the PRI pressure Ppri before the switching.

In this example, by the switching of the switching valve 36 as described above, the PRI pressure Ppri is decreased as being dragged by the PRI-side pressure Pc1 and thus the hydraulic pressure fluctuation of the PRI pressure Ppri occurs.

Meanwhile, the speed ratio of the variator 2 is changed as described below during the transition of switching. That is, when the PRI pressure Ppri starts to decrease in the middle term of the transition, the speed ratio of the variator 2 starts to change to the low side. Then, in the later term of the transition, the speed ratio of the variator 2 further changes to the low side due to the hydraulic pressure fluctuation of the PRI pressure Ppri.

As a result, in this example, the PRI pressure Ppri decreases most due to the hydraulic pressure fluctuation at the time T3, and, at this time, the speed ratio of the variator 2 becomes the lowest speed ratio and the movable pulley 21b contacts the stopper 21d.

Therefore, even if the PRI pressure Ppri further greatly decreases due to the hydraulic pressure fluctuation, for example, the speed ratio of the variator 2 is not further changed to the low side and thus the shift shock caused by the hydraulic pressure fluctuation of the PRI pressure Ppri falls within the allowable range.

The second position P2 of the switching valve 36 can be applied at the time of the sailing stop of the engine ENG, for example. The sailing stop is a driving-source automatic stop control, and is executed when a sailing stop condition is satisfied.

The sailing stop condition includes: that the vehicle speed VSP is a middle or high speed (equal to or larger than a predetermined vehicle speed); that there is no depression of the accelerator pedal; and that there is no depression of the brake pedal. Like the idling stop condition, the sailing stop condition is satisfied when all conditions included in the sailing stop condition are satisfied, and is not satisfied when any of the conditions included in the sailing stop condition is not satisfied.

Therefore, in Step S1 of the flowchart illustrated in FIG. 4, the controller 10 can determine whether there is a switching request for the switching valve 36 from the first position P1 to the second position P2 by determining whether the sailing stop condition is satisfied. Moreover, the controller 10 can determine whether there is a switching request for the switching valve 36 from the second position P2 to the first position P1 by determining whether the sailing stop condition is not satisfied.

FIG. 6 is a diagram illustrating a second example of a timing chart corresponding to the flowchart illustrated in FIG. 4. A case where the sailing stop condition is satisfied, accordingly a case where the switching of the switching valve 36 is performed from the first position P1 to the second position P2 will be explained in FIG. 6.

At a time T11, the engine ENG is in operation and the switching position of the switching valve 36 is the first position P1. The PRI pressure Ppri is constituted by the PRI-side pressure Pc1, and the SEC pressure Psec is set to be higher than the PRI pressure Ppri. The SOL pressure Pc2 is atmospheric pressure.

At the time T11, the speed ratio of the variator 2 is closer to the highest speed ratio, and the difference a is equal to or less than the predetermined value α1. When the switching of the switching valve 36 is performed at the time of executing or stopping the sailing stop, the difference a specifically is a difference between the actual speed ratio of the variator 2 and the speed ratio at which the movable pulley 22b contacts the stopper 22d, that is, the highest speed ratio. The specific numerical value of the predetermined value α1 may be different from the case of the first example, or may be set individually and specifically in accordance with the switching direction of the switching valve 36, the stopping and running of the vehicle, or the like.

When the switching of the switching valve 36 is performed from the first position P1 to the second position P2, the SOL pressure Pc2 can be adjusted to the PRI-side pressure Pc1 by the PRI pressure solenoid 42 in preparation for the switching of the switching valve 36. Therefore, in this example, the SOL pressure Pc2 starts to increase at a time T12 and the SOL pressure Pc2 has the same magnitude as the PRI-side pressure Pc1 at a time T13.

At a time T14, the sailing stop condition is satisfied, and the switching request for the switching valve 36 from the first position P1 to the second position P2 occurs. Therefore, a switching command for the switching valve 36 is issued as indicated by a dashed line, and the switching of the switching valve 36 is started. The switching of the switching valve 36 is during the transition from the time T14 to a time T15.

When the switching of the switching valve 36 is performed from the first position P1 to the second position P2, the rotation direction of the electric oil pump 32 is switched from a forward direction to a reverse direction in the middle term of the transition in accordance with the satisfaction of the sailing stop condition. Thus, without decreasing the PRI pressure Ppri constituted by the PRI-side pressure Pc1 by the switching of the rotation direction, the electric oil pump 32 can be used as a pump for source pressure.

Meanwhile, the automatic stop of the engine ENG is already in progress in the middle term of the transition. Therefore, just after switching the rotation direction, the supply flow rate of the electric oil pump 32 may be temporarily short of the required flow rate required to maintain the SEC pressure Psec adjusted by the line pressure adjusting valve 34. Then, when the supply flow rate of the electric oil pump 32 is actually short of the required flow rate, the SEC pressure Psec temporarily decreases and thus the hydraulic pressure fluctuation of the SEC pressure Psec occurs. As a result, the speed ratio of the variator 2 changes to the high side according to this.

In this example, when the SEC pressure Psec decreases most due to the hydraulic pressure fluctuation, the speed ratio of the variator 2 becomes the highest speed ratio and the movable pulley 22b contacts the stopper 22d.

Therefore, even if the SEC pressure Psec further greatly decreases due to the hydraulic pressure fluctuation, for example, the speed ratio of the variator 2 is not further changed to the high side and thus the shift shock caused by the hydraulic pressure fluctuation of the SEC pressure Psec falls within the allowable range.

Next, main effects according to the present embodiment will be explained.

Regarding a control method for the power transmission device according to the present embodiment, the power transmission device includes the variator 2, the first oil passage R1 to communicate between the PRI pulley oil chamber 21c and the SEC pulley oil chamber 22c, the electric oil pump 32 provided in the first oil passage R1, the second oil passage R2 branching off from the first oil passage R1 between the electric oil pump 32 and the PRI pulley oil chamber 21c and communicating with the oil reservoir 37, the switching valve 36 provided at the branch point of the first oil passage R1 and the second oil passage R2, and the third oil passage R3 branching off from the first oil passage R1 between the electric oil pump 32 and the SEC pulley oil chamber 22c and reaching the switching valve 36. Moreover, the switching valve 36 switches between two positions of the first position P1 at which at least the first oil passage R1 is set to the communication state and the second position P2 at which the second oil passage R2 and the first oil passage R1 on the SEC pulley oil chamber 22c side are set to the communication state and the third oil passage R3 and the first oil passage R1 on the PRI pulley oil chamber 21c side are set to the communication state.

The control method for the power transmission device according to the present embodiment includes: determining whether the difference a is equal to or less than the predetermined value α1; and performing the switching of the switching valve 36 when it is determined that the difference a is equal to or less than the predetermined value α1.

According to the method thus configured, even if the PRI pulley 21 operates due to the hydraulic pressure fluctuation of the PRI pressure Ppri according to the switching of the switching valve 36, the operation of the PRI pulley 21 can be stopped by making the movable pulley 2 lb contact the stopper 21d. Therefore, while the oil in the oil reservoir 37 can be supplied to the PRI pulley oil chamber 21c via the electric oil pump 32 for shift by the switching of the switching valve 36, the shift shock according to the switching of the switching valve 36 can be suppressed. The same applies to the SEC pulley 22 including the movable pulley 22b and the stopper 22d.

The predetermined value α1 is a value by which the change in vehicle acceleration due to the hydraulic pressure fluctuation of the PRI pressure Ppri or the SEC pressure Psec when performing the switching of the switching valve 36 is within the allowable range. Thus, the shift shock can be appropriately suppressed.

Even if it is determined that the difference a is equal to or less than the predetermined value a 1, the switching of the switching valve 36 from the switching position P2 to the switching position P1 may be prevented from being performed without permission. Thus, when switching the switching valve 36 from the switching position P2 to the switching position P1, it is possible to prevent a situation in which the shift shock occurs due to the decrease in the PRI pressure Ppri even if the difference a is equal to or less than the predetermined value a 1.

The controller 10 may be configured to perform the control described hereinafter.

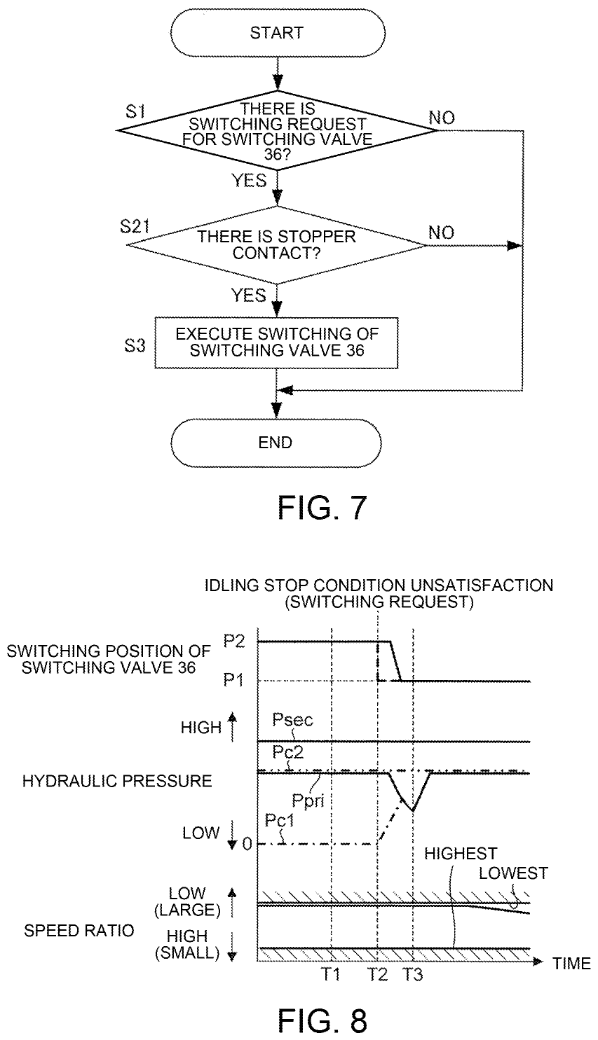

FIG. 7 is a flowchart illustrating a modified example of control performed by the controller 10. The present flowchart is different from the flowchart illustrated in FIG. 4 in that Step S21 is provided instead of Step S2. Therefore, Step S21 will be mainly explained herein.

In Step S21, the controller 10 determines whether there is stopper contact. The stopper contact includes contact between the movable pulley 21b and the stopper 21d and contact between the movable pulley 22b and the stopper 22d.

The determination of the former contact can be performed when executing or stopping the idling stop, for example, and can be performed by determining whether the speed ratio of the variator 2 is the lowest speed ratio. The determination of the latter contact can be performed when executing or stopping the sailing stop, for example, and can be performed by determining whether the speed ratio of the variator 2 is the highest speed ratio. The processings are once terminated if a negative determination is made in Step S21, and the processings proceed to Step S3 if a positive determination is made in Step S21.

That is, in this modified example, the switching of the switching valve 36 according to the switching request is performed in a state where there is the stopper contact. As a result, even if the hydraulic pressure fluctuation of the PRI pressure Ppri or the SEC pressure Psec occurs in accordance with the switching of the switching valve 36, the speed ratio of the variator 2 is not changed and the shift shock is prevented because an operation of the variator 2 according to this hydraulic pressure fluctuation is prevented.

FIG. 8 is a diagram illustrating an example of a timing chart corresponding to the modified example illustrated in FIG. 7. Hereinafter, parts different from those of the timing chart illustrated in FIG. 5 will be mainly explained.

In this example, at a time T1, the speed ratio of the variator 2 is the lowest speed ratio. Moreover, by starting the switching of the switching valve 36 when the speed ratio of the variator 2 is the lowest speed ratio at a time T2, the switching of the switching valve 36 is started in a state where the movable pulley 21b is in contact with the stopper 21d.

Therefore, during the transition of switching between the time T2 and a time T3, even if the PRI pressure Ppri decreases due to the hydraulic pressure fluctuation and the speed ratio of the variator 2 tries to change to the low side, the speed ratio of the variator 2 is not changed and the shift shock due to a change in the speed ratio does not occur. After the time T3, the speed ratio is changed to the high side in accordance with the vehicle speed VSP. Even in such a modified example, it is possible to suppress the shift shock according to the switching of the switching valve 36.

As described above, the embodiment of the present invention has been explained, but the above embodiment is only a part of the application example of the present invention and the technical scope of the present invention is not intended to be limited to the specific configurations of the above embodiment.

The case where the switching of the switching valve 36 is performed in accordance with the satisfaction and unsatisfaction of the idling stop condition or the sailing stop condition has been explained in the embodiment described above. However, the switching of the switching valve 36 may be performed in accordance with the satisfaction and unsatisfaction of a coast stop condition, for example.

The coast stop condition is a condition including that the vehicle speed VSP is less than a predetermined vehicle speed VSP2, that there is no depression of the accelerator pedal, that there is depression of a brake pedal, and that a forward range is selected in a continuously variable transmission TM. The predetermined vehicle speed VSP2 is the vehicle speed VSP in a low speed range, and specifically is the vehicle speed VSP at which the lock-up LU is disengaged.

The coast stop condition includes that the vehicle speed VSP is a low vehicle speed (less than a set vehicle speed predetermined), that there is no depression of the accelerator pedal, that there is depression of the brake pedal, and that the forward range is selected in the transmission 1. For example, the set vehicle speed is the vehicle speed VSP at which the lock-up clutch LU is disengaged. The coast stop condition is satisfied when all conditions included in the coast stop condition are satisfied and is not satisfied when any of the conditions included in the coast stop condition is not satisfied.

In the case of the satisfaction and unsatisfaction of the coast stop, the speed ratio of the variator 2 may be closer to the highest speed ratio due to a preset condition such as failure. In this case, the same control as that of the sailing stop can be applied.

In the embodiment described above, it has been explained that the control method for the power transmission device is realized by the controller 10. However, the control method for the power transmission device may be realized by a single controller such as the transmission controller 11.

This application is based upon and claims the benefit of priority from Japanese Patent Application No. 2017-254762 filed with the Japan Patent Office on Dec. 28, 2017, the entire contents of which are incorporated herein by reference.

1.-5. (canceled)

6. A control method for a power transmission device,
the power transmission device including:
a continuously variable transmission mechanism configured to perform power transmission between a driving source and driving wheels;
a first oil passage communicating between a primary pulley oil chamber and a secondary pulley oil chamber of the continuously variable transmission mechanism;
an electric oil pump provided in the first oil passage;
a second oil passage branching off from the first oil passage between the electric oil pump and the primary pulley oil chamber and communicating with an oil reservoir;
a switching valve provided at a branch point of the first oil passage and the second oil passage; and
a third oil passage branching off from the first oil passage between the electric oil pump and the secondary pulley oil chamber and reaching the switching valve,
the switching valve being configured to switch between two positions of:
a first position at which at least the first oil passage is set to a communication state; and
a second position at which the second oil passage and the first oil passage on a secondary pulley oil chamber side are set to a communication state with each other and the third oil passage and the first oil passage on the primary pulley oil chamber side are set to a communication state with each other, and
the control method comprising:
determining whether a difference between an actual speed ratio of the continuously variable transmission mechanism and a maximum speed ratio or a minimum speed ratio, the maximum speed ratio or the minimum speed ratio being a speed ratio at which an axial movable part of a primary pulley or a secondary pulley of the continuously variable transmission mechanism contacts a stopper, is equal to or less than a predetermined value; and
performing a switching of the switching valve when being determined that the difference is equal to or less than the predetermined value.

7. The control method for the power transmission device according to claim 6, wherein the predetermined value is a value by which a change in vehicle acceleration due to hydraulic pressure fluctuation of a pulley pressure of the primary pulley or the secondary pulley when performing the switching of the switching valve is within an allowable range.

8. A control method for a power transmission device,
the power transmission device including:
a continuously variable transmission mechanism configured to perform power transmission between a driving source and driving wheels;
a first oil passage communicating between a primary pulley oil chamber and a secondary pulley oil chamber of the continuously variable transmission mechanism;
an electric oil pump provided in the first oil passage;
a second oil passage branching off from the first oil passage between the electric oil pump and the primary pulley oil chamber and communicating with an oil reservoir;
a switching valve provided at a branch point of the first oil passage and the second oil passage; and
a third oil passage branching off from the first oil passage between the electric oil pump and the secondary pulley oil chamber and reaching the switching valve,
the switching valve being configured to switch between two positions of:
a first position at which at least the first oil passage is set to a communication state; and
a second position at which the second oil passage and the first oil passage on a secondary pulley oil chamber side are set to a communication state with each other and the third oil passage and the first oil passage on a primary pulley oil chamber side are set to a communication state with each other, and
the control method comprising:
determining whether there is contact between a stopper and an axial movable part of a primary pulley or a secondary pulley of the continuously variable transmission mechanism; and
performing a switching of the switching valve when being determined that there is the contact.

9. A control device for a power transmission device,
the power transmission device including:
a continuously variable transmission mechanism configured to perform power transmission between a driving source and driving wheels;
a first oil passage communicating between a primary pulley oil chamber and a secondary pulley oil chamber of the continuously variable transmission mechanism;
an electric oil pump provided in the first oil passage;
a second oil passage branching off from the first oil passage between the electric oil pump and the primary pulley oil chamber and communicating with an oil reservoir;
a switching valve provided at a branch point of the first oil passage and the second oil passage; and
a third oil passage branching off from the first oil passage between the electric oil pump and the secondary pulley oil chamber and reaching the switching valve,
the switching valve being configured to switch between two positions of:
a first position at which at least the first oil passage is set to a communication state; and
a second position at which the second oil passage and the first oil passage on a secondary pulley oil chamber side are set to a communication state with each other and the third oil passage and the first oil passage on a primary pulley oil chamber side are set to a communication state with each other, and
the control device comprising a controller configured to:
determine whether a difference between an actual speed ratio of the continuously variable transmission mechanism and a maximum speed ratio or a minimum speed ratio, the maximum speed ratio or the minimum speed ratio being a speed ratio at which an axial movable part of a primary pulley or a secondary pulley of the continuously variable transmission mechanism contacts a stopper, is equal to or less than a predetermined value; and
perform a switching of the switching valve when being determined that the difference is equal to or less than the predetermined value.

10. A control device for a power transmission device,
the power transmission device including:
a continuously variable transmission mechanism configured to perform power transmission between a driving source and driving wheels;
a first oil passage communicating between a primary pulley oil chamber and a secondary pulley oil chamber of the continuously variable transmission mechanism;
an electric oil pump provided in the first oil passage;
a second oil passage branching off from the first oil passage between the electric oil pump and the primary pulley oil chamber and communicating with an oil reservoir;
a switching valve provided at a branch point of the first oil passage and the second oil passage; and
a third oil passage branching off from the first oil passage between the electric oil pump and the secondary pulley oil chamber and reaching the switching valve,
the switching valve being configured to switch between two positions of:
a first position at which at least the first oil passage is set to a communication state; and
a second position at which the second oil passage and the first oil passage on a secondary pulley oil chamber side are set to a communication state with each other and the third oil passage and the first oil passage on a primary pulley oil chamber side are set to a communication state with each other, and
the control device comprising a controller configured to:
determine whether there is contact between a stopper and an axial movable part of a primary pulley or a secondary pulley of the continuously variable transmission mechanism; and
perform a switching of the switching valve when being determined that there is the contact.
